(19) United States
(12) Patent Application Publication
(10) Pub. No.: US 2023/0316253 A1
(43) Pub. Date: Oct. 5, 2023

(54) METHOD FOR INFLUENCING FEE DISTRIBUTION ACROSS A PAYMENT NETWORK USING A DYNAMIC PAYMENT CARD NUMBER

(71) Applicant: Conghua Yan, Southlake, TX (US)

(72) Inventor: Conghua Yan, Southlake, TX (US)

(21) Appl. No.: 17/707,595

(22) Filed: Mar. 29, 2022

(51) Int. Cl. G06Q 20/20; G06Q 20/32; G06Q 20/34

(52) U.S. Cl. CPC G06Q 20/204; G06Q 20/326; G06Q 20/34

(57) ABSTRACT

A method comprising receiving a merchant information associated with a potential purchase utilizing a user account via a mobile payment application, determining a set of payment network routings for the potential purchase, creating a list of usable payment card numbers of the user account associated with the set of payment network routings, comparing the set of payment network routines having associated fee distributions, electing a payment network routing based at least in part on the associated fee distributions, creating a dynamic payment card number with the elected payment network routing, assigning the dynamic payment card number to the user account, notifying a payment card issuer of the dynamic payment card number and returning the dynamic payment card number to the mobile payment application.

### BACKGROUND

### Technical Field

The instant disclosure is related to dynamic payment card creation and specifically to utilizing influencing fee distributions across a payment network using a dynamic payment card number.

### Background

Mobile payments utilize physical cards loaded into a virtual wallet. The cardholder may choose a payment card without presenting the physical card and the system utilizes the physical card information stored in their mobile wallet. However, regardless of which card the cardholder choses, it has no effect on the payment card processing fee distribution from the point that the payment card is chosen.

### SUMMARY

An example method includes receiving a merchant information associated with a potential purchase utilizing a user account via a mobile payment application, determining a set of payment network routings for the potential purchase, creating a list of usable payment card numbers of the user account associated with the set of payment network routings, comparing the set of payment network routings having associated fee distributions, electing a payment network routing based at least in part on the associated fee distributions, creating a dynamic payment card number with the elected payment network routing, assigning the dynamic payment card number to the user account, notifying a payment card issuer of the dynamic payment card number and returning the dynamic payment card number to the mobile payment application.

An example system includes a credit card magnetic track simulator responsive to a processor, the credit card magnetic track simulator is slidable in an point of sale card reader to pay for a potential purchase, wherein the processor, receives a merchant information associated with the potential purchase utilizing a user account via a mobile payment application, determines a set of payment network routings for the potential purchase, creates a list of usable payment card numbers of the user account associated with the set of payment network routings, compares the set of payment network routings having associated fee distributions, elects a payment network routing based at least in part on the associated fee distributions, creates a dynamic payment card number with the elected payment network routing, assigns the dynamic payment card number to the user account, notifies a payment card issuer of the dynamic payment card number, and returns the dynamic payment card number to the mobile payment application, and a non-transitory memory communicably coupled to the processor, wherein the memory stores the dynamic payment card number.

### DESCRIPTION OF THE DRAWINGS

In the drawings:

FIG. 1 is a first example system diagram in accordance with one embodiment of the disclosure;

FIG. 2 is a second example system diagram in accordance with one embodiment of the disclosure;

FIG. 3 is an example flow of prior art mobile payment;

FIG. 4 is an example flow of mobile payment in accordance with one embodiment of the disclosure;

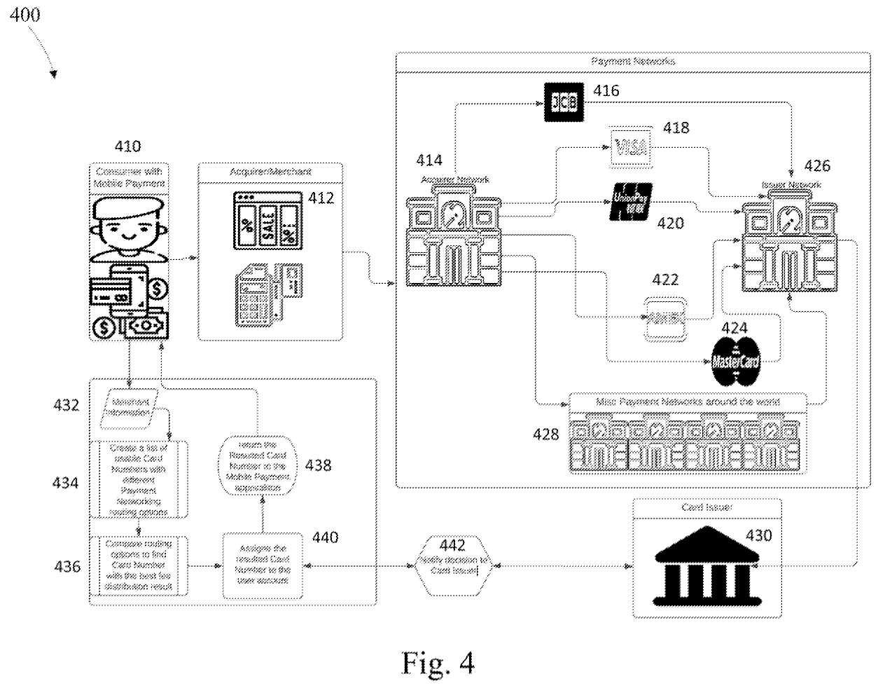

FIG. 5 is an example method in accordance with one embodiment of the disclosure; and

FIG. 6 depicts an example of a credit card magnetic track simulator coupled to a mobile device.

### DETAILED DESCRIPTION OF THE INVENTION

The embodiments listed below are written only to illustrate the applications of this apparatus and method, not to limit the scope. The equivalent form of modifications towards this apparatus and method shall be categorized as within the scope the claims.

Certain terms are used throughout the following description and claims to refer to particular system components. As one skilled in the art will appreciate, different companies may refer to a component and/or method by different names. This document does not intend to distinguish between components and/or methods that differ in name but not in function.

In the following discussion and in the claims, the terms “including” and “comprising” are used in an open-ended fashion, and thus may be interpreted to mean “including, but not limited to . . . .” Also, the term “couple” or “couples” is intended to mean either an indirect or direct connection. Thus, if a first device couples to a second device that connection may be through a direct connection or through an indirect connection via other devices and connections.

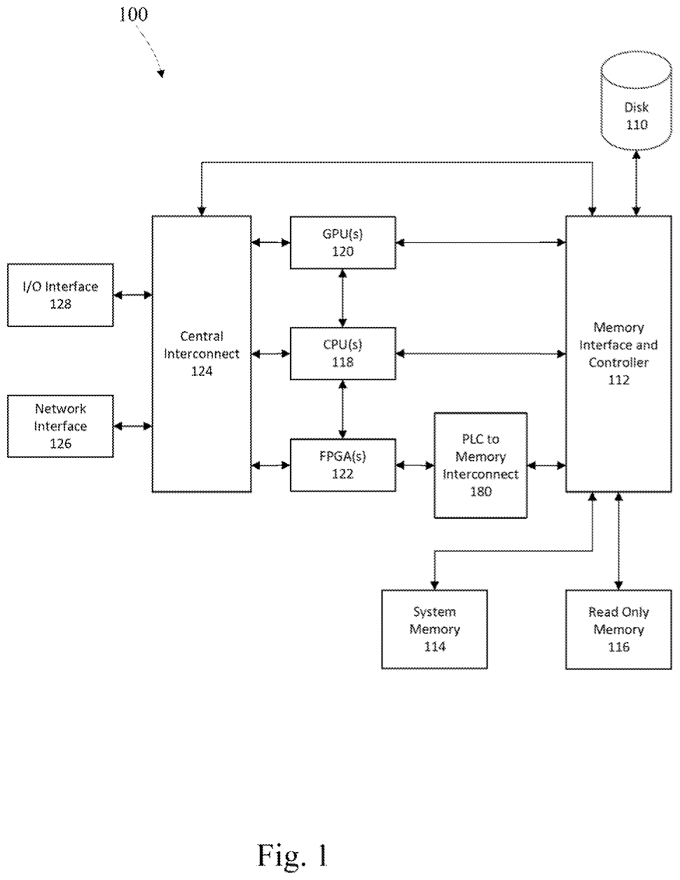

FIG. 1 depicts an example hybrid computational system 100 that may be used to implement neural nets associated with the operation of one or more portions or steps of the processes. In this example, the processors associated with the hybrid system comprise a field programmable gate array (FPGA) 122, a graphical processor unit (GPU) 120 and a central processing unit (CPU) 118.

The CPU 118, GPU 120 and FPGA 122 have the capability of providing a neural net. A CPU is a general processor that may perform many different functions, its generality leads to the ability to perform multiple different tasks, however, its processing of multiple streams of data is limited and its function with respect to neural networks is limited. A GPU is a graphical processor which has many small processing cores capable of processing parallel tasks in sequence. An FPGA is a field programmable device, it has the ability to be reconfigured and perform in hardwired circuit fashion any function that may be programmed into a CPU or GPU. Since the programming of an FPGA is in circuit form, its speed is many times faster than a CPU and appreciably faster than a GPU.

There are other types of processors that the system may encompass such as an accelerated processing unit (APUs) which comprise a CPU with GPU elements on chip and digital signal processors (DSPs) which are designed for performing high speed numerical data processing. Application specific integrated circuits (ASICs) may also perform the hardwired functions of an FPGA; however, the lead time to design and produce an ASIC is on the order of quarters of a year, not the quick turn-around implementation that is available in programming an FPGA.

The graphical processor unit 120, central processing unit 118 and field programmable gate arrays 122 are connected and are connected to a memory interface controller 112. The FPGA is connected to the memory interface through a programmable logic circuit to memory interconnect 130. This additional device is utilized due to the fact that the FPGA is operating with a very large bandwidth and to minimize the circuitry utilized from the FPGA to perform memory tasks. The memory and interface controller 112 is additionally connected to persistent memory disk 110, system memory 114 and read only memory (ROM) 116.

The system of FIG. 1A may be utilized for programming and training the FPGA. The GPU functions well with unstructured data and may be utilized for training, once the data has been trained a deterministic inference model may be found and the CPU may program the FPGA with the model data determined by the GPU.

The memory interface and controller is connected to a central interconnect 124, the central interconnect is additionally connected to the GPU 120, CPU 118 and FPGA 122. The central interconnect 124 is additionally connected to the input and output interface 128 and the network interface 126.

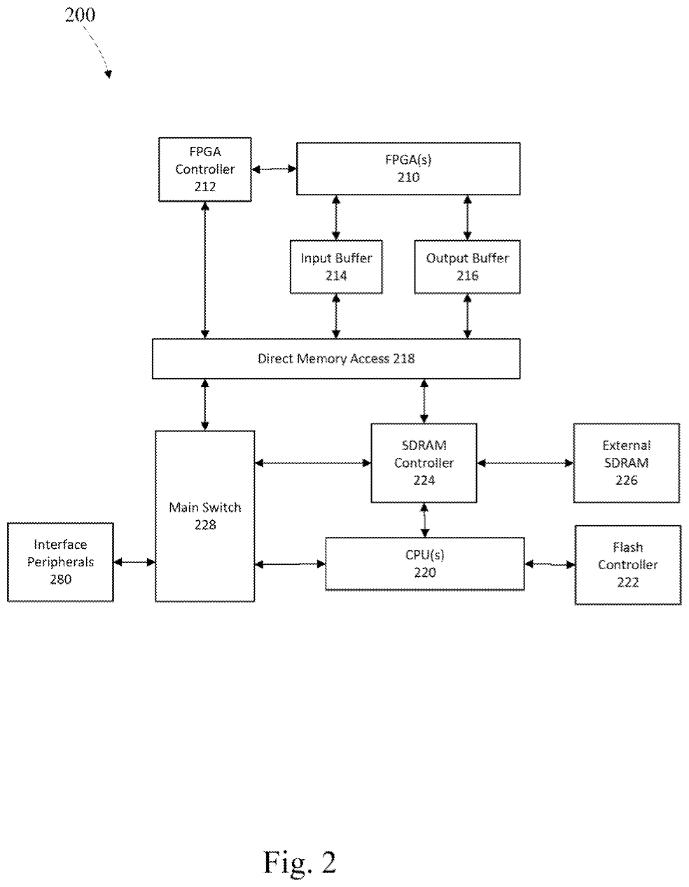

FIG. 2 depicts a second example hybrid computational system 200 that may be used to implement neural nets associated with the operation of one or more portions or steps of process 1000. In this example, the processors associated with the hybrid system comprise a field programmable gate array (FPGA) 210 and a central processing unit (CPU) 220.

The FPGA is electrically connected to an FPGA controller 212 which interfaces with a direct memory access (DMA) 218. The DMA is connected to input buffer 214 and output buffer 216, which are coupled to the FPGA to buffer data into and out of the FPGA respectively. The DMA 218 includes of two first in first out (FIFO) buffers one for the host CPU and the other for the FPGA, the DMA allows data to be written to and read from the appropriate buffer.

On the CPU side of the DMA are a main switch 228 which shuttles data and commands to the DMA. The DMA is also connected to an SDRAM controller 224 which allows data to be shuttled to and from the FPGA to the CPU 220, the SDRAM controller is also connected to external SDRAM 226 and the CPU 220. The main switch 228 is connected to the peripherals interface 230. A flash controller 222 controls persistent memory and is connected to the CPU 220.

In a traditional payment card transaction, a cardholder chooses a physical card from wallet and utilizes that card to pay at a merchant terminal. The merchant terminal sends the payment card information to the merchant processor and the merchant processor sends the payment card information to a payment card network switch. The payment card network switch sends the payment card information the payment card issuer, the party which owns the account balance of the payment card. The payment card issuer approves the transaction and sends the approval to the merchant terminal at which point the purchase transaction is completed.

In one traditional payment card transaction example if the cardholder uses a VISA card to spend $1000 to buy a TV. A customer purchases the TV after transaction is completed. During the settlement stage, $1000 will be deducted from the cardholder's account. The merchant terminal owner does not receive the $1000. Currently, a merchant terminal owner pays 1% to 5% to the merchant processor depending on the agreement merchant terminal owner signed with merchant processor.

If the agreement stipulates a 3% fee, out of every $100 the merchant terminal owner receives $97. The merchant processor also has an agreement with the payment card network switch. If the merchant processor pays 1.5% to the payment card network switch, the merchant processor keeps $1.5. The payment card network switch pays the payment card issuer also which may be 0.5%. The payment card network switch keeps $1 and the payment card issuer keeps $0.5. When settlement is completed, each party receives a different amount with the merchant terminal owner receiving $97, the merchant processor receiving $1.5, payment card network switch receiving $1 and the payment card issuer receiving $0.5.

The $3 discussed above is normally referred to as the payment card processing fee. It is not always 3%, and depends on the merchant type, transaction volume, merchant location and many other factors. How the payment card processing fee is distributed between each party also varies. In the United States, AMEX and Discover run their own networks and issue their own cards, therefore AMEX and Discover keep both the payment card network switch and payment card issuer fees. In some countries where AMEX and Discover have no presence, they use other payment card networks to process the transaction. For example, the AMEX card transaction may be run through the Visa Network, then Visa passes the transaction onto AMEX network. There are also examples where that the payment card issuer owns merchant processor, so the transaction will reach the payment card issuer directly, bypassing other payment card network switches. There may be many regional, national or multiple nations networks which process the transition internally without reaching any VISA/Master card network. Depending on the various merchants and payment card types, the payment card processing scenario is very dynamic and how the processing fee is distributed is also dynamic.

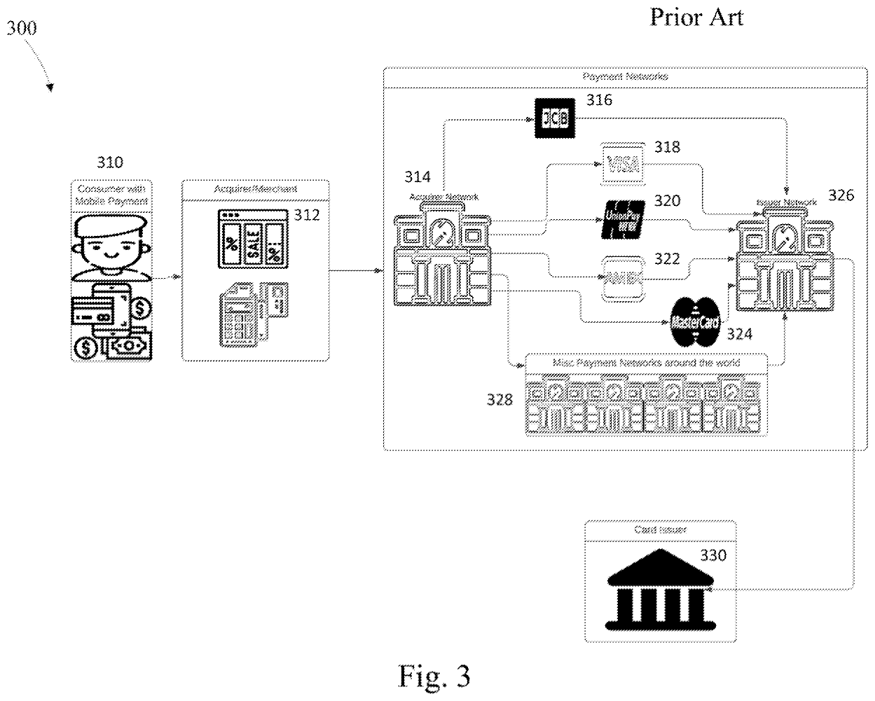

When the mobile payment system was first introduced, the physical cards were loaded into a virtual wallet. The as shown in FIG. 3 300, a cardholder 310 choses the payment card to use, but they did not present the physical card. Instead, they use the physical card information stored in their mobile wallet. No matter which payment card the cardholder chooses at specific merchant. It did not affect the payment card processing fee distribution method at the backend. The merchant terminal 312 sends the payment card information to the merchant processor and the merchant processor sends the payment card information to a payment network that includes an acquirer network 314 having a payment card network switch that has multiple different network routing options such as JCB 316, VISA 318, Union Pay, 320 AMEX 322, MasterCard 324, or miscellaneous payment networks around the world 328 sent to an issuer network 326. The payment card network switch sends the payment card information the payment card issuer 330, the party that owns the account balance of the payment card. The payment card issuer approves the transaction and sends the approval to the merchant terminal at which point the purchase transaction is completed.

The mobile payment technology owner and the payment card issuer may identify the payment card processing fee distribution method at the specific merchant terminal location. The mobile payment technology owner may generate a dynamic payment card number that is linked to the cardholder's account, that dynamic payment card number may affect the routing path during the payment card processing. The proposed solution chooses a payment card processing fee distribution method which will maximize one party's benefit. Any party (merchant terminal owner, merchant processor, payment card network switch, payment card issuer) may be the new mobile payment technology owner. The current method utilizes static payment card numbers that utilize static payment card processing fee distributions.

A payment card number is commonly 15-16 digits long but may be as many as 19 digits or as few as 13 digits in some regions. The first 6 digits are known as a bank identification number (BIN), regulated under the ISO/IEC 7812 standard. The 7th to the number before last number identifies the cardholder account. The last number is normally a check digit number to verify that the payment card number is genuine. To determine a card scheme, 2 factors are used, payment card number length and the card prefix up to 6 digits. Once a card scheme is determined, a routing routine is determined at specific merchant site. Therefore, the dynamic payment card number has a length and a numeric structure that matches the routing routine for that specific merchant site.

Currently a consumer's existing payment card number is utilized to finish a financial transaction at merchant site. Each payment card number has its own routing routine, and different routing routine results different processing fee distributions. The fee distribution difference affects each transaction processing party may range from 1% to 5%. The utilization of a dynamic payment card number allows modification of the processing fee distribution. The payment card number may be one input to determine the output fee distribution result, the proposed solution generates a dynamic payment card number to influence the result which may be used to benefit one or more parties in the processing.

The mobile payment application may communicate with a processing module, online or offline, to generate a dynamic payment card number with a bank identification number. That bank identification number with its routing routine will serve the best interest under the processing module. Options include the payment card issuer getting the largest percentage from the processing fee distribution or the merchant getting the largest percentage from the processing fee distribution scheme. For example, a payment card issuer may receive 1% processing fee from a toy store when Visa card number was used, by switching to a Master card number at that site, that payment card issuer might receive 1.5% processing fee.

The processing module of generating a dynamic payment card number may take multiple forms that include an artificial Intelligence module to make selection based on historical payment card processing history and fixed patterns based on historical payment card processing histories.

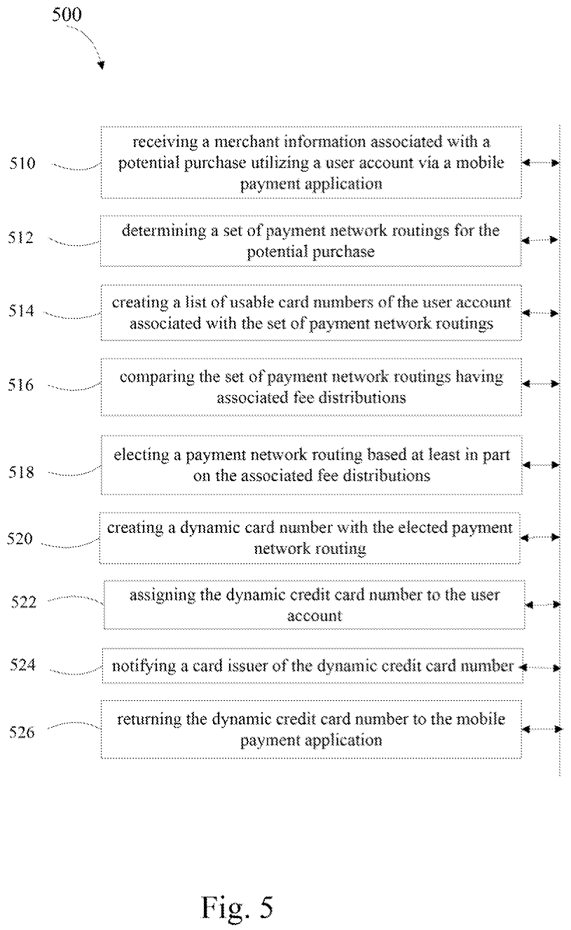

FIG. 5 depicts method of dynamic payment card creation 500, including, receiving 510 a merchant information associated with a potential purchase utilizing a user account via a mobile payment application and determining 512 a set of payment network routings for the potential purchase. The method also includes creating 514 a list of usable payment card numbers of the user account associated with the set of payment network routings, comparing 516 the set of payment network routings having associated fee distributions and electing 518 a payment network routing based at least in part on the associated fee distributions. The method further includes creating 520 a dynamic payment card number with the elected payment network routing, assigning 522 the dynamic payment card number to the user account, notifying 524 a payment card issuer of the dynamic payment card number and returning 526 the dynamic payment card number to the mobile payment application.

The method may also include displaying the associated fee distributions of the set of payment network routings and or a set of historical data of the user account and or a set of historical data of the merchant information. The method may include selecting the elected payment network routing based on a set of historical data of the user account and or a set of historical data of the merchant information wherein the dynamic payment card number has a limited life or is one-time use. The method may include a dynamic payment card number having a number length and or numerical structure that matches the elected payment network routing.

In one embodiment, the dynamic card numbers may be pre-allocated to the mobile wallet owner depending upon a user's predicted travel pattern. For example, when the user travels from the USA to Japan, once the mobile wallet application detects the user is in Japan, a pre-allocated card number may be loaded to the mobile wallet and a corresponding assignment made to the user's host account. The dynamic card number allocation method may be applied prior to or during a merchant purchase transaction. For example, if the user travels to Japan once a quarter, the dynamic card numbers may be pre-allocated to the owner's mobile wallet just prior to the predicted travel pattern. The prediction of a user's travel pattern may be done on a periodic basis or may be based on the purchase of tickets, the reservation of rooms, the review of the user's schedule and the like. The method may comprise determining a travel pattern of the user account and pre-allocating the dynamic payment card number to the user account based on the travel pattern.

The election of the payment network routing may be based upon the merchant information, the payment card numbers, the associated fee distributions, and a set of maximum percentages of at least one of a clearing fee amounts and a transaction amount and the mobile payment application may run on at least one of a point of sale terminal, a smart bracelet, a smart watch and a smart device.

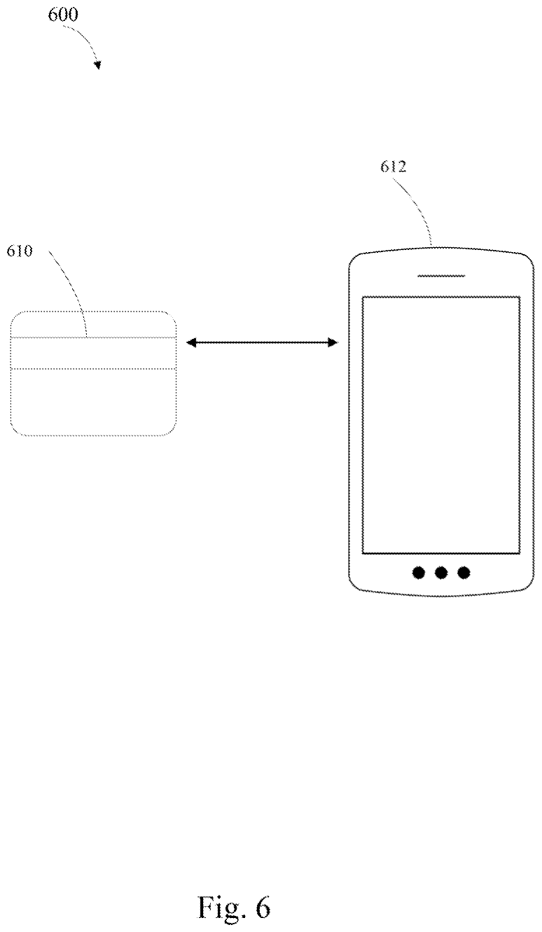

FIG. 6 depicts an example credit card magnetic track simulator 610 which may be slid along a card reader slot and its connection to a mobile device 612. In this example the coupling of the credit card magnetic track simulator to mobile device is by RF communication such as near field communication, but may be hard wired, and the like. The mobile device may be any smart device such as a cell phone, tablet, bracelet or watch and the like.

One embodiment may comprise a system including a credit card magnetic track simulator responsive to a processor, the credit card magnetic track simulator may be slidable in an point of sale card reader to pay for a potential purchase. The processor may receive a merchant information associated with the potential purchase utilizing a user account via a mobile payment application, determine a set of payment network routings for the potential purchase and create a list of usable payment card numbers of the user account associated with the set of payment network routings. The processor may also compare the set of payment network routings having associated fee distributions, elect a payment network routing based at least in part on the associated fee distributions and create a dynamic payment card number with the elected payment network routing. The processor may also assign the dynamic payment card number to the user account, notify a payment card issuer of the dynamic payment card number, and return the dynamic payment card number to the mobile payment application. A non-transitory memory may be communicably coupled to the processor, wherein the memory stores the dynamic payment card number.

The processor of the system may display the associated fee distributions of the set of payment network routings and or select the elected payment network routing based on a set of historical data of the user account and or select the associated fee distributions based on a set of historical data of the user account. The processor may further select the elected payment network routing based on a set of historical data of the merchant information and or select the associated fee distributions based on a set of historical data of the merchant information. The processor may reside on at least one of a mobile device, a smart device and a point of sale terminal. The payment network routing election may be based upon the merchant information, the payment card numbers, the associated fee distributions, and a set of maximum percentages of at least one of a clearing fee amount and a transaction amount.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the system. Skilled artisans may implement the described functionality in varying ways for each particular application. Various components and blocks may be arranged differently (e.g., arranged in a different order, or partitioned in a different way) without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects may be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention. The predicate words “configured to”, “operable to”, and “programmed to” do not imply any particular tangible or intangible modification of a subject, but, rather, are intended to be used interchangeably. For example, a processor configured to monitor and control an operation, or a component may also mean the processor being programmed to monitor and control the operation or the processor being operable to monitor and control the operation. Likewise, a processor configured to execute code may be construed as a processor programmed to execute code or operable to execute code.

A phrase such as an “aspect” does not imply that such aspect is essential to the subject technology or that such aspect applies to configurations of the subject technology. A disclosure relating to an aspect may apply to configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to configurations of the subject technology. A disclosure relating to an embodiment may apply to embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to configurations of the subject technology. A disclosure relating to a configuration may apply to configurations, or one or more configurations. A configuration may provide one or more examples. A phrase such as a “configuration” may refer to one or more configurations and vice versa.

The word “example” is used herein to mean “serving as an example or illustration.” Any aspect or design described herein as “example” is not necessarily to be construed as preferred or advantageous over other aspects or designs.

Structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

References to “one embodiment,” “an embodiment,” “some embodiments,” “various embodiments”, or the like indicate that a particular element or characteristic is included in at least one embodiment of the invention. Although the phrases may appear in various places, the phrases do not necessarily refer to the same embodiment. In conjunction with the present disclosure, those skilled in the art may be able to design and incorporate any one of the variety of mechanisms suitable for accomplishing the above-described functionalities.

It is to be understood that the disclosure teaches just one example of the illustrative embodiment and that many variations of the invention may easily be devised by those skilled in the art after reading this disclosure and that the scope of then present invention is to be determined by the following claims.

What is claimed is:

1. A method, comprising:
receiving a merchant information associated with a potential purchase utilizing a user account via a mobile payment application;
determining a set of payment network routings for the potential purchase;
creating a list of usable payment card numbers of the user account associated with the set of payment network routings;
comparing the set of payment network routings having associated fee distributions;
electing a payment network routing based at least in part on the associated fee distributions;
creating a dynamic payment card number with the elected payment network routing;
assigning the dynamic payment card number to the user account;
notifying a payment card issuer of the dynamic payment card number; and
returning the dynamic payment card number to the mobile payment application.

2. The method of claim 1 further comprising displaying the associated fee distributions of the set of payment network routings.

3. The method of claim 1 further comprising selecting the elected payment network routing based on a set of historical data of the user account.

4. The method of claim 1 further comprising selecting the associated fee distributions based on a set of historical data of the user account.

5. The method of claim 1 further comprising selecting the elected payment network routing based on a set of historical data of the merchant information.

6. The method of claim 1 further comprising selecting the associated fee distributions based on a set of historical data of the merchant information.

7. The method of claim 1 wherein the dynamic payment card number has one of a limited life or a one-time use.

8. The method of claim 1 further comprising:
determining a travel pattern of the user account; and
pre-allocating the dynamic payment card number to the user account based on the travel pattern.

9. The method of claim 1 wherein the dynamic payment card number has a number length that matches the elected payment network routing.

10. The method of claim 1 wherein the dynamic payment card number has a numeric structure that matches the elected payment network routing.

11. The method of claim 1 wherein the payment network routing election is based upon the merchant information, the payment card numbers, the associated fee distributions, and a set of maximum percentages of at least one of a clearing fee amount and a transaction amount.

12. The method of claim 1 wherein the mobile payment application runs on at least one of a point of sale terminal, a smart bracelet, a smart watch and a smart device.

13. A system, comprising:
a credit card magnetic track simulator responsive to a processor, the credit card magnetic track simulator is slidable in an point of sale card reader to pay for a potential purchase;
wherein the processor,
receives a merchant information associated with the potential purchase utilizing a user account via a mobile payment application;
determines a set of payment network routings for the potential purchase;
creates a list of usable payment card numbers of the user account associated with the set of payment network routings;
compares the set of payment network routings having associated fee distributions;
elects a payment network routing based at least in part on the associated fee distributions;
creates a dynamic payment card number with the elected payment network routing;
assigns the dynamic payment card number to the user account;
notifies a payment card issuer of the dynamic payment card number; and
returns the dynamic payment card number to the mobile payment application; and
a non-transitory memory communicably coupled to the processor, wherein the memory stores the dynamic payment card number.

14. The system of claim 13 wherein the processor displays the associated fee distributions of the set of payment network routings.

15. The system of claim 13 wherein the processor selects the elected payment routing based on a set of historical data of the user account.

16. The system of claim 13 wherein the processor selects associated fee distributions based on a set of historical data of the user account.

17. The system of claim 13 wherein the processor selects the elected payment network routing based on a set of historical data of the merchant information.

18. The system of claim 13 wherein the processor selects the associated fee distributions based on a set of historical data of the merchant information.

19. The system of claim 13 wherein the processor is resident on at least one of a mobile device, a smart device and a point of sale terminal.

20. The system of claim 13 wherein the payment network routing election is based upon the merchant information, the payment card numbers, the associated fee distributions, and a set of maximum percentages of at least one of a clearing fee amount and a transaction amount.
